(19) United States
(12) Patent Application Publication
(10) Pub. No.: US 2002/0038309 A1
(43) Pub. Date: Mar. 28, 2002

(54) System integration framework

(75) Inventors: Mathew Nicholas Perkins, Calgary (CA); Robert James Church, Calgary (CA); Noel Roberts, Calgary (CA)

Correspondence Address: BENNETT JONES, C/O MS ROSEANN CALDWELL, 4500 BANKERS HALL EAST, 855 - 2ND STREET, SW, CALGARY, AB, T2P 4K7, CA

(73) Assignee: ARIA SOLUTIONS INC.

(21) Appl. No.: 09/682,416

(22) Filed: Aug. 30, 2001

(30) Foreign Application Priority Data
Aug. 30, 2000 (CA) 2,318,287

(51) Int. Cl. G06F 7/00

(52) U.S. Cl. 707/104.1; 707/10

(57) ABSTRACT

A system and method for integrating one or more external systems, where the integration is achieved through the collaboration of an engine and one or more adapters. The engine can be configured with a set of rules that defines how messages are distributed among the adapters, and is responsible for enforcing those rules. Each adapter is associated with an external system. Each adapter is responsible for translating messages received from the associated external system into a common messaging protocol and for transmitting the translated messages to the engine. In addition, each adapter is responsible for translating messages in the common messaging protocol received from the engine and for transmitting the translated messages to the associated external system. Engines and adapters may be distributed among several computers.

### CROSS REFERENCE TO RELATED APPLICATIONS

The present application claims the benefit of Canadian Patent Application 2,318,287 filed Aug. 30, 2000, which application is hereby incorporated herein by reference in its entirety including its drawings.

### BACKGROUND OF INVENTION

The present invention is in the area of communication between computer systems, and pertains more particularly to methods for communicating messages between computer systems in real time.

About this Document1.1Purpose and Scope

This document describes the motivation behind the development of Argon and presents a brief overview of the Argon framework.

1.2Audience

This document is written for software developers, information services personnel, and other technical people who are considering using Argon to streamline the development and maintenance of a contact center solution.

2.What is Argon?

Argon is a collection of pre-built software components that can be used to dramatically reduce the amount of effort required to develop, deploy, and maintain contact center solutions.

3.Why Argon3.1The Motivation

Much of the motivation behind the development of Argon has been to solve the addressable problems that the engineers at Aria Solutions Inc. continuously encounter while working on computer telephony integration (CTI) projects. It was observed that, although each project had certain aspects that were unique, there was a great deal of effort being expended solving the same problems over and over. In addition, it was becoming clear that certain Internet technologies were maturing rapidly and could be used to simplify various tasks or even remove them altogether.

3.2Anatomy of a CTI Project

A CTI project involves making your telephone network talk to your computer network in such a way that allows you to better serve your customers, make more sales, and make more money. A CTI project typically involves the following tasks.

3.2.1Programming the IVR

When a customer calls your customer service line the call is answered by a computer and an automated voice asks her to enter her account number on her touch tone phone. This is the IVR. Typically, the IVR asks you to enter some kind of identification number. The IVR associates the identification number with the call. This is how your computers know, to whom you are speaking on the phone. Usually, the IVR provides a self-service menu to the caller. Typically the self-service menu allows to perform tasks that she can efficiently do for herself such as check her account balance, change her address, or pay a bill. The self-service menu is typically available twenty four hours a day, seven days a week (24×7), giving the caller access to your business even during those times when your office is closed.

The IVR must be programmed so that it knows how to respond to touch-tones and what messages to play. Messages are recorded and an IVR script is written that defines the behavior of the IVR.

3.2.2Programming the Interaction Router

Of course, some interactions require a real live human being on the other end of the line. Typically the IVR allows the user to press a digit, usually zero, to speak to a customer care representative. This is where call routing comes in. When the caller presses zero to speak to a customer care representative, focus shifts to routing the call to the real live human being who is best equipped to handle it. Call routing is usually based on where the caller was in the IVR menu structure when they pressed zero and the set of information identified by the caller's identification number. This set of information is often called the customer profile. The people who take the calls, the customer care representatives or contact center agents can be set up with skills that have specific scores. An example of a skill might be the ability to speak French. If the caller's customer profile indicates that they speak French the call will be routed the available agent that has the highest score in the French skill. If none of the available contact center agents speak French, the call waits in a call queue until a French-speaking agent becomes available. While the call is waiting in the queue, every so often a message is played to the caller indicating how important her call is and so on. In addition, the caller may have purchased a certain level of service. This service level is recorded in the caller's customer profile and can be used to prioritize her call among all the other calls that are waiting to be serviced.

Routing is handled by a piece of software called an interaction router. The interaction router must be programmed to retrieve the customer profile from a database so that it can be checked against agent skills. The interaction router may also associate customer profile information with the call so that it can be displayed by an application running on the target agent's desktop computer. Typically, the programming is embedded in a routing script that defines how calls are to be routed.

Note that the piece of software that routes the calls is called an interaction router rather than a call router because it can route other interactions besides calls. Typically, skill-based routing can also be applied to emails and chat sessions.

3.2.3Developing and Deploying the Desktop Client Application

After the call has been routed to the appropriate agent's phone, the focus shifts to getting the information that is associated with the caller to the agent that receives the call. Usually this information is associated with the call by the interaction router and is displayed in an application window that makes itself visible when the target agent's phone rings. Typically, this desktop application also includes a set of controls called the soft phone that allow the agent to perform telephony operations such as answer, hang up, transfer, conference, hold, and retrieve from his computer. Often, a contact center agent that is equipped with a headset and a desktop client application can handle calls using their computer without having to touch the physical phone. A piece of software called a telephony server talks to the phone switch and makes phone switch events and requests available to the computer network so that the client application knows when a particular agent's phone rings and can submit requests to control the call.

The desktop application is usually custom written in a programming language such as Microsoft Visual Basic, Java, or C++ and must be deployed each agent's desktop.

3.2.4Designing and Implementing Interaction Reports

Interaction reports are designed so that you can track the performance of your contact center. These reports allow you to identify how long customers are kept waiting in queues, how many customers abandon the call before it reaches an agent, how long on average agents spend handling calls, etc. For example, you might find that at certain times the contact center gets a flood of calls and customers end up waiting too long in call queues. This may indicate that you should plan to deploy more agents at these times.

Often, the desktop client application provides a mechanism by which an agent can associate wrap-up codes with an interaction. Wrap-up codes indicate what a call was regarding. Some examples of wrap-up are purchase, complaint, billing, personal information change, general inquiry, etc.

Interaction reports that involve wrap-up codes give you insight into your business. For example, if you suddenly get a flood of calls about billing, this may indicate there is a problem with your billing process or perhaps the bill that you are sending to customers is unclear.

In any case, the reports that are required to illuminate these important patterns of call center interactions have to be designed and implemented.

3.3Problems with the Traditional Desktop Client Application

It was determined that the many of the addressable problems associated with computer telephony integration surround the desktop client application. This is because the development of the desktop client application requires the bulk of the custom programming. In addition, the desktop client application, unlike the routing and IVR scripts, have to be deployed on each agent's desktop.

It was observed that most of the problems surrounding the desktop client application result from the following:

3.3.1A Lack of Separation

Business and CTI logic is often intertwined in the desktop client applications. This meant that a new client application would have to be developed for each customer even though the CTI logic was essentially the same. In addition, even simple changes to business content required expensive computer telephony expertise to avoid breaking existing CTI logic.

3.3.2Ubiquitous Deployment Issues

Deployment of the client applications on even a small number of desktops posed significant problems. There would often be conflicts with other applications. Sometimes, there would be a lack of resources on the desktops. Often, customers would insist that the deployment of the desktop client application be performed by an already over-burdened information services staff, resulting in delays.

3.4Traditional Desktop Client Applications Resist Change

Traditional desktop client applications are simply not dynamic enough to keep up with the changing needs of most businesses. Once the desktop client application has been deployed it becomes difficult to change it. Firstly, because the CTI and business logic is not sufficiently separated, making changes to the desktop client application requires an experienced CTI programmer. Experienced CTI programmers are uncommon and expensive. Secondly, because the benefit of each change is weighed against the substantial effort that is required to deploy that change on all agent desktops, many changes do not get deployed.

In business it is important to be able to capitalize on opportunities. The desktop client performs a very important function in your contact center. It delivers the information that an agent needs to service a customer at the exact moment of contact. When a customer or potential customer contacts your organization, this presents an opportunity. An opportunity to build a relationship, make more contacts, make another sale. The desktop client delivers the information that the contact center agent needs to capitalize on these opportunities. As time races on at Internet speed, opportunities change, sometimes overnight. To allow contact center agents to fully capitalize on new opportunities as they arise, the desktop client has to be dynamic. The desktop client has to deliver the appropriate information for each new opportunity.

### SUMMARY OF INVENTION

Welcome to ArgonArgon gives you the power to capitalize on opportunities by giving control over information delivery to the person that knows your business, you.

With Argon the desktop client application is deployed as a set of web pages that are downloaded and executed in a web browser. To start the Argon Web Client the agent simply navigates their browser to the designated universal resource locator (URL) and logs in. As long as a compatible browser exists no client-side installation is required.

The Argon Web Client appears as a separate window that is divided into frames. There is a soft phone frame that provides buttons such as answer, hang up, transfer, etc. that allows the agent to control phone calls. There is a short cuts frame that gives the agent quick ways to deal with a call such as, transfer to sales, and transfer to collections. It is up to you to define what short cuts appear. Finally, there is a large frame called the content frame. Although, typically, information such as the customer profile appears in the content frame when the agent's phone rings, the information that appears in the content frame is completely up to you.

Navigate your browser to another URL and the Argon Administration Client appears. The Argon Administration Client allows you to define the behavior of the Argon Web Client. With a few mouse clicks you can specify what URL you would like to appear in the content frame when a particular telephony event occurs. With a few more mouse clicks you can also specify what information you would like to appear in the request to that URL. In most cases you would at least specify that the caller's identification number be passed along. Similarly, you can define what short cuts should appear in the short cuts frame, when a particular event occurs. Any changes that you make using the Argon Administration Client will take affect when the next contact center agent logs in to a web client.

This short description illustrates how Argon solves the problems associated with traditional CTI client development.

Business logic and CTI logic are separate. The task of creating the server-side script that displays business content in the Argon web client can be given to a web developer without that web developer having to know anything about CTI. All the web developer needs to know is that at the appropriate time the server-side script will be invoked, with the customer identification number as a parameter. The server-side script can be written and tested independently of CTI activities.

Argon inherits none of the deployment problems encountered with traditional CTI client applications, because client-side deployment is virtually non-existent.

### BRIEF DESCRIPTION OF DRAWINGS

FIG. 1 is a UML object diagram illustrating the general engine-adapter model of an embodiment of the invention.

FIG. 2 is a UML object diagram illustrating configuration of the engine in an embodiment of the invention.

FIG. 3 is a UML object diagram illustrating CTI client application using the general engine-adapter model of FIG. 1.

FIG. 4 is a UML object diagram illustrating the general agent model used in an embodiment of the invention

FIG. 5 is a UML object diagram illustrating the portal agent model used in an embodiment of the invention

FIG. 6 is a UML deployment diagram illustrating a fully distributed CTI system that is an embodiment of the invention.

FIG. 7 is a UML class association diagram illustrating message types used in an embodiment of the invention.

FIG. 8 is a UML class association diagram illustrating the custom adapter server classes used in an embodiment of the invention.

### DETAILED DESCRIPTION

The Argon Framework

5.1 The Engine Adapter Model

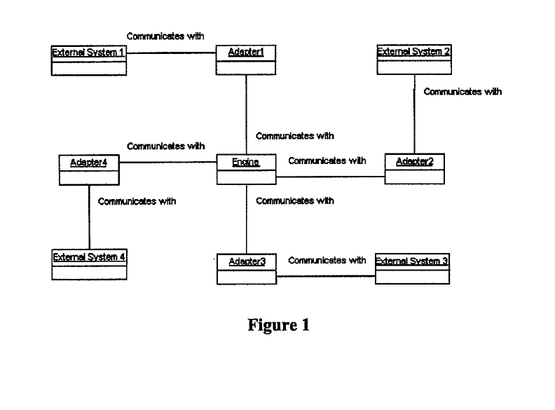

At the heart of the Argon framework lies the engine-adapter model. The general engine-adapter model is depicted with a UML object diagram in FIG. 1.

The behavior of Argon clients such as the Argon Web Client is controlled by an object called an engine. The purpose of the engine is to distribute Argon messages among adapter objects according to the rules that are specified in the engine's configuration. Adapter objects are responsible for communicating with systems that are external to Argon. Each adapter objects translates between the Argon messaging protocol (AMP) and whatever protocols or interfaces are supported by the associated external system.

5.2Engine Configuration

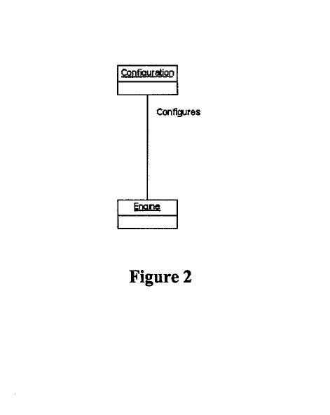

Engines are configured by a configuration object, depicted in FIG. 2.

When the engine is created it is given the URL of a server-side script that produces the configuration. The engine creates a configuration object and passes the URL to it. The configuration object connects to the URL and receives a stream of XML. Contained within the XML are the rules that define how the engine distributes messages among the associated adapters.

The server-side script generates the XML by querying the Argon configuration database. This is the database that you are modifying when you make changes with the Argon administration client. You can get a good idea of what the configuration XML will look like when you click on an application's XML link in the Argon Administration Client.

5.3Argon CTI Client Application

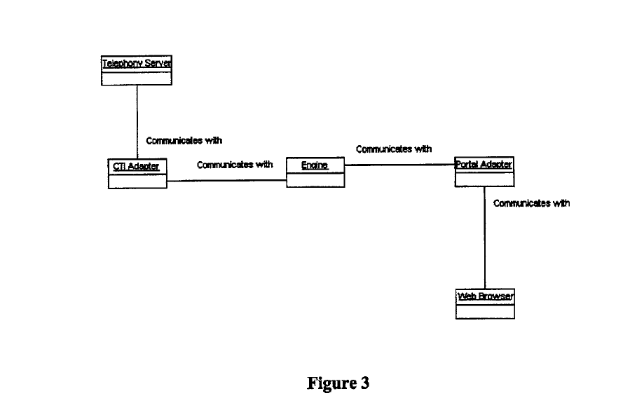

The Argon CTI client application is a specialization of the general engine-adapter model is depicted with a UML object diagram in FIG. 3.

In the case of the CTI client application, there are two external systems, the telephony server and the web browser.

The CTI adapter translates between calls to the telephony server interface and Argon messages. For example, when the agent's phone rings the CTI adapter is notified and sends an Argon event message to the engine. If the engine sends a request to the CTI adapter to answer a call, the CTI adapter makes the appropriate call through the telephony server interface.

The portal adapter translates between calls to the browser interface and Argon messages. For example, when an agent clicks the answer button on the web client soft phone, the portal adapter is notified and sends an Argon event message to the engine. If the engine sends a request to navigate the web client content pane to a specific URL, the portal adapter makes the appropriate call to the browser interface.

5.4Argon Agent Model

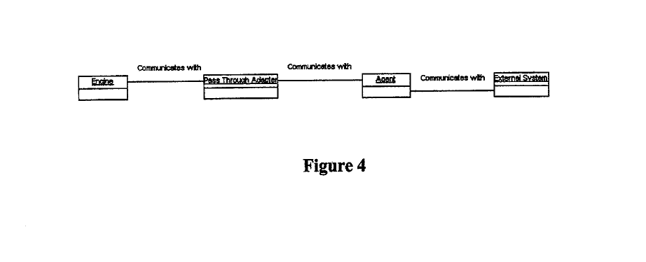

The portal adapter is somewhat more sophisticated than other adapters like the CTI adapter because it employs an object called an agent. The general Argon agent model is depicted in a UML object diagram in FIG. 4.

An agent is an object that is paired with a special kind of adapter called a pass through adapter. The adapter is called a pass through adapter because most of its work involves distributing messages to and from the agent. It is the agent that actually does the work of converting between the Argon messaging protocol and whatever protocol is supported by the associated external system. This means that the Argon messaging protocol is used between the engine and the pass through adapter as well as between the pass through adapter and the agent.

5.5Portal Agent

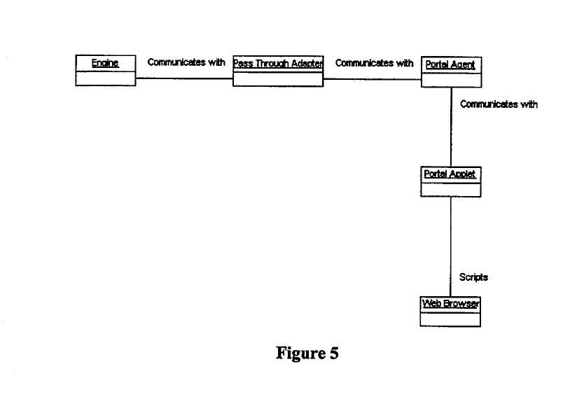

The portal agent is depicted with a UML object diagram in FIG. 5. Note that the pass through adapter, portal agent and the portal applet together are thought of as the portal adapter.

The Argon Web Client includes an invisible frame that contains an applet called the Argon portal applet. This applet is loaded into the frame and executed when a contact center agent logs in. The portal agent is created as part the portal applet when the portal applet is executed. When the portal agent is created, it establishes a connection to the associated pass through adapter, essentially making the web client visible to the rest of the Argon framework. The web pages that are loaded into the web browser send and receive Argon messages by making calls (scripting) the portal applet which forwards those calls on to the portal agent. This is how the web browser knows, as an example, when the agent's phone rings.

5.6Deployment

Argon is written in Java, and is, therefore, largely platform independent.

Argon adapters, engines, and configuration objects are instantiated by server objects that run inside an Argon run-time environment. An Argon run-time environment is a class that executes in a single Java virtual machine. The Argon run time environment houses one or more Argon servers, and provides services such as logging. When an Argon run-time environment is deployed, it is associated with an XML file, which specifies attributes of the Argon run-time environment such as how to perform logging, as well as, which Argon server to run, and for each Argon server what arguments are required.

Because the server objects communicate with sockets, they can be deployed in a variety of ways. Server objects can be deployed on a single machine in a single Java virtual machine, on a single machine in separate Java virtual machines, or on multiple networked machines in separate Java virtual machines.

The capacity of the Argon system is increased, by deploying additional Argon servers on new machines. You have the choice of, static load balancing by assigning certain agents or applications to particular servers, or having the Argon framework perform round-robin load balancing as engines and adapters are created.

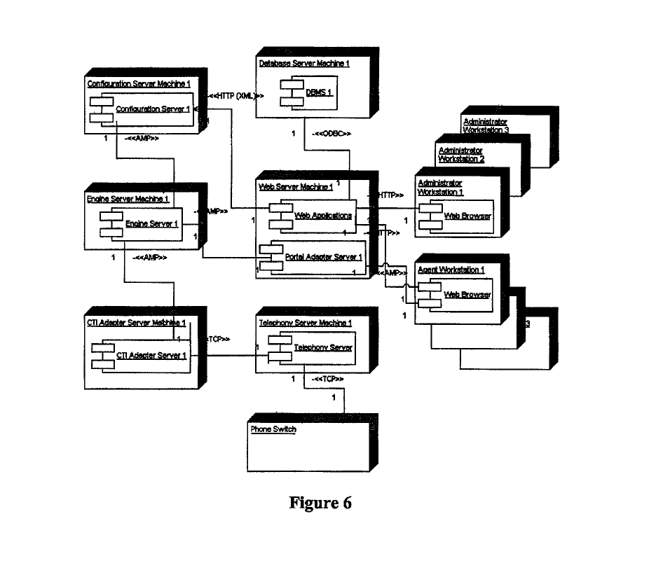

FIG. 6 is a UML deployment diagram that depicts a fully distributed Argon system where only the basic server types exist.

In addition to the Argon servers, the following servers are required:

ODBC Compliant Database Server

An Argon system requires an ODBC compliant database server to store Argon configuration information

Web Server

An Argon system requires at least one web server to serve the web pages belonging to the Argon Web Client and Argon Administration Client.

Telephony Server

This Argon system requires a telephony server from a supported CTI vendor, so that the Argon CTI adapter can invoke the functionality of the phone switch.

Note that the portal adapter server is deployed on the web server. This is because, generally, applets can only make connections back to the web server that served them.

6.Argon Messaging6.1Argon Message Types

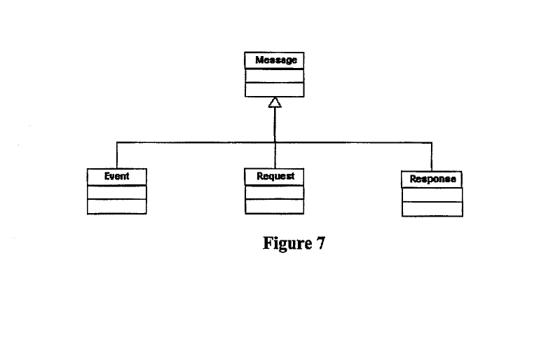

Argon messages fall into the three types that are depicted with a UML class association diagram in FIG. 7. All Argon messages are derivations of the following three message types.

6.1.1Event Message

The event message is an unsolicited message that is sent from some object to indicate that some event has occurred.

6.1.2Request Message

The request message is a message that is sent to invoke some functionality in the destination object. A request message generates a unique transaction identifier that is used to match the request with the associated response.

6.1.3Response Message

The response message is a message that conveys the result of a particular request. The response message maintains the unique transaction identifier of the associated request, so that the response and request can be matched.

6.2Argon Message Categories

In addition, Argon messages also fall into the following categories:6.2.1 Management Messages

These are messages that Argon servers send to one another to manage Argon objects, such as requests to create and destroy adapter, engine, and configuration objects.

6.2.2Configuration Messages

These are the messages that a configuration object sends to an engine to define that engine's behavior, such as requests to add adapters, actions, and conditions.

6.2.3Generic Messages

These are the messages that are distributed among engines and adapters that result in or result from interactions with in external systems such as the telephony server or the Argon Web Client.

Generic messages are different from other messages in that the Argon engine does not know what the message means. Imagine that you create an action using the Argon Administration Client to send the pop request to the portal adapter when a ringing event arrives from the CTI adapter. When a ringing event arrives, the engine doesn't know that you are displaying a web page. All that the engine knows is that when an event called EventRinging arrives from adapter called the CTI adapter, it has to send a generic request called Portal.RequestPop to an adapter called the Portal Adapter. The engine also knows that a generic Argon event has a tree of key value pairs embedded within it. When you specify that you want key url.parameter.acctNum in the request to equal userData.ACCT_NB in the event. The engine copies the value at userData.ACCT_NB in the data tree of the EventRinging event into url.parameter.acctNum in the data tree of the Portal.RequestPop request. The engine has no idea that this value is an account number.

The Argon adapters know the business of interacting with non-Argon systems.

The CTI adapter understands that when a ringing event arrives from the telephony server it has to create a generic generic Argon event called EventRinging, generate an Argon data tree from the data that the telephony server has sent with the event, and send it to the engine. Similarly the portal adapter understands that when it gets a generic request called Portal.RequesPop, it should take the url.name, url.parameters, and targetFrame values out of the request data tree, construct a URL, and load it into the target frame.

Adapter requests, events, and data trees are defined in an adapter schema that is imported into the Argon configuration database. The Argon administration client queries adapter schemas in order to populate choice lists when you are building configurations.

7.0Customization

The Argon framework has been designed to allow a great deal of customization. The following sections enumerate all the ways in which an Argon system can be customized.

7.1 Customizing the Portal (Argon Web Client)

You can change the functionality that the portal exposes to Argon by adding to the JavaScript code that is included in the applet and soft phone frames of the Argon web client. Any functionality that you add can be made available to the Argon administration client by changing the portal adapter schema.

You can also change any part of the web client's user interface. The soft phone and short cuts user interface is dynamic html rather than applets so you are free to change the look and feel however you like.

7.2Custom Adapter Servers

If you would like to integrate one or more external systems that make up your business into the Argon framework, you can do it by creating a custom adapter server. Argon comes with a Java class library that allows you to create your own custom adapter servers. You will have to know something about object-oriented programming to do it.

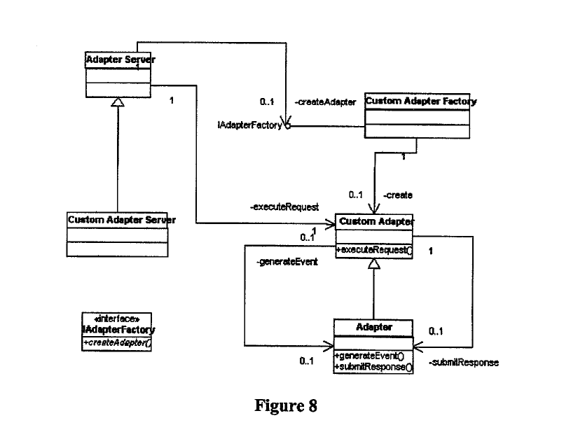

Depicted in FIG. 8 is a UML class association diagram that shows the classes that are involved.

The Argon framework is designed so that when you create a custom adapter server, you can concentrate on exposing the functionality provided by some external system, instead of worrying about the plumbing. In the diagram in FIG. 7, you implement the classes that have “custom” in the name. Of course, you are free to give them whatever name you like. In any case, you will need to implement a custom adapter, a custom adapter factory, and a custom adapter server.

Your custom adapter class extends the base adapter class. To add custom request-handling functionality to your adapter, override the executeRequest method. This is the method that the Argon framework will call to notify your adapter that a request has arrived. It is important that your custom adapter's executeRequest method not do anything that will block your adapter server. Argon adapter servers are single threaded which means that any adapter requests that arrive, must wait in a queue until the adapter server has finished processing any previous requests. To generate events and submit responses call the generateEvent and submitResponse methods on the adapter base class. Don't forget to include the transaction ID of the associated requests, when you submit responses. The Argon framework will take care of sending the appropriate generic message to the associated engine.

Your custom adapter server class extends the base adapter server class. In its constructor, your custom adapter server will need to call the constructor of the adapter server base class with a reference to your custom adapter factory. The Argon framework uses the supplied adapter factory to create instances of your custom adapter as required.

When you get it running don't forget to import the schema for the your custom adapter into the Argon configuration database so that the Argon Administration Client see it.

7.3Windows Client Services

If you have Windows client application that already exists on your contact center desktops, you can create an Argon client service application that allows you to expose interactions with that client to the Argon framework. An Argon client service is a Windows application that typically runs minimized on each client desktop, something like a PC Anywhere host.

To integrate with a Windows client application, you simply embed a client service control into your client service application. The client service control accepts connections from client service adapters. Argon comes with a client service adapter server that hosts the client service adapters. The client service control exposes an executeRequest event, a sendEvent method and a sendResponse method that can be used to communicate with the Argon framework.

Because you decide what requests and events your client service exposes, you are responsible for creating the adapter schema for your client service adapter. Don't forget to import the schema for your client service into the Argon configuration database so that the Argon Administration Client can see it.

7.4Custom Configuration Scripts

The server-side script that generates the XML that is used to configure Argon engines can be modified or completely replaced as long as the Argon configuration objects see a valid XML stream.

1] A system for communicating messages in real time between a first external system and a second external system, comprising:
an engine;
a first adapter capable of communicating with the first external system and the engine, the first adapter configurable to translate messages in a first protocol received from the first external system into a common messaging protocol and transmit the translated messages to the engine and to translate messages in the common messaging protocol received from the engine into the first protocol and transmit such translated messages back to the first external system; and
a second adapter capable of communicating with the second external system and the engine, the second adapter configurable to translate messages in a second protocol received from the second external system into a common messaging protocol and transmit the translated messages to the engine and to translate messages in the common messaging protocol received from the engine into the second protocol and transmit such translated messages back to the second external system,
the engine configurable to apply a set of rules to messages received from one adapter and transmit messages formulated in accordance with the set of rules to the other adapter or to both adapters.

2. The system of claim 1, wherein the first adapter is a CTI adapter, the first external system is a telephony server, the second adapter is a portal adapter, and the second external system is a web browser.
